(19) United States
(12) Patent Application Publication
(10) Pub. No.: US 2011/0088138 A1
(43) Pub. Date: Apr. 21, 2011

(54) Heating inner part for gloves

(76) Inventor: Shu-Lien Chen, Taichung (TW)

(21) Appl. No.: 12/588,466

(22) Filed: Oct. 16, 2009

(51) Int. Cl. A41D 19/00; H05B 3/00

(52) U.S. Cl. 2/160; 219/211

(57) ABSTRACT

An inner part for a glove includes a palm pouch and a finger pouch and an outer bag is mounted to the finger pouch and includes four finger pockets. A receiving pocket is located on the palm pouch and has a cover for sealing the receiving pocket. An electro-heat unit includes a heat plate, a power source and a controller, the heat plate is electrically connected to the power source by a cable and the controller is electrically connected to the power source. The heat plate includes four insertion plates so as to be inserted into the finger pouches and each insertion plate has a heating item which is powered by electric power to provide temperature to the wearer's fingers.

### FIELD OF THE INVENTION

The present invention relates to heating gloves, and more particularly, to a heating part of gloves wherein the inner part has removable electro-heat unit for providing warm to the wearers.

### BACKGROUND OF THE INVENTION

There are fine blood vessels spread in peoples' finger tips and the fine blood vessels shrink in cold weather so that the blood cannot flow to the finger tips and which makes people feel cold and even numb. Some people work at low temperature and need to wear gloves to keep the fingers warm. The conventional gloves are made by fabrics, leather or other known material and can be made to be a single-layer or multiple layers. The single layer gloves are flexible so that the users can easily operate the fingers, but the single layer gloves cannot keep the hands warm. On the contrary, multiple layer gloves can have cottons or feathers received between the layers so as to easily keep the warm with the wearer's hands. The multiple layer gloves have an inherent shortcoming which is that the gloves are bulky and the fingers cannot operate as that when wearing the single layer gloves.

FIGS. 1 and 2 show a conventional electro-heat glove 11 which includes a heating wire 114 and an isolation layer 116 received between the inner layer 112 and the outer layer 118 of the glove 11. A cover 13 has one end fixed on a back of the glove 11 and the other end of the cover 13 is attached to the back of the glove 11 by using hook-loop strips. The heating wire 114 is connected to a cable 122 and a plug 12 is connected to a distal end of the cable 122, the cable 122 extends through the isolation layer 116 and the outer layer 118 of the glove 11 so as to plug the plug 12 to a power supply which is not shown. The temperature generated by the heating wire 114 can be kept by the isolation layer 116 so that the users feel warm and comfortable when wearing the gloves 11. The plug 12 and the cables 122 are then received in a pocket sealed by the cover 13 when removing the plug 12 from the power source.

However, the heating wire 114, the cable 122 and the plug 12 are made with the glove 11 so that the glove 11 has to avoid from being touched by water which might cause short to the circuit of the heating wire 114.

Besides, it is difficult to clean the heating wire 114 because the heating wire 114 is secured between the inner layer 112 and the isolation layer 116. The heating wire 114 cannot be replaced with new one so that the whole glove 11 is discarded if the heating wire 114 is damaged. The glove 11 is discarded if the heating wire 114 is in good condition but the inner layer 112 or the outer layer 1.18 is damaged.

The present invention intends to provide an inner part for a glove which includes an outer bag with four finger pockets and a electro-heat unit is inserted into the four finger pockets to provide temperature to the wearer's fingers.

### SUMMARY OF THE INVENTION

The present invention relates to an inner part for a glove and the inner part comprises a palm pouch and a finger pouch which is connected to the palm pouch. The palm ouch includes a first opening so that the wearer's hand can be inserted into the inner part via the first opening. An outer bag is mounted to the finger pouch and includes multiple finger pockets. A receiving unit is located on the palm pouch and includes a receiving pocket which has a cover removing sealing a second opening of the receiving pocket. An electro-heat unit includes a heat plate, a power source and a controller, wherein the heat plate is electrically connected to the power source by a cable and the controller is electrically connected to the power source. The heat plate includes multiple insertion plates and each insertion plate has a heating item received therein. The heating items are connected to the cable and heated by electric power. The insertion plates are removably inserted into the finger pockets, and the power source and the controller are received in the receiving pocket.

The primary object of the present invention is to provide an inner part of a glove wherein the inner part includes finger pockets in which heating items are inserted. The heating items are connected to a power source and a controller, both of which are received in a receiving pocket on the palm pouch. The heating items and the power source and the controller can be easily removed from the inner part.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is a perspective view to show the conventional electro-heat glove with the cable and plug extending from the glove;

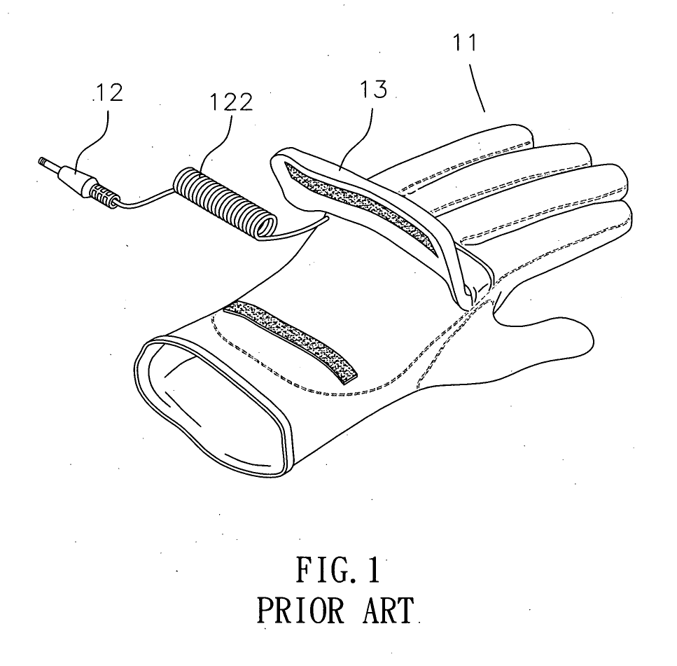

FIG. 2 is a cross sectional view to show the heating wire located between the inner layer and the isolation layer and the outer layer of the conventional electro-heat glove;

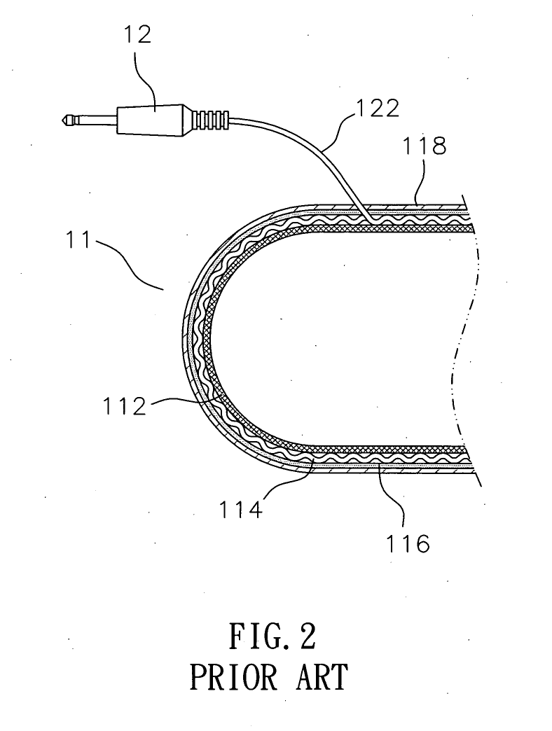

FIG. 3 is a perspective view to show the heating inner part of the present invention;

FIG. 4 is an exploded view to show the electro-heat unit and the heating inner part of the present invention, and

FIG. 5 is a perspective view to show the heating inner part of the present invention.

### DETAILED DESCRIPTION OF THE PREFERRED EMBODIMENT

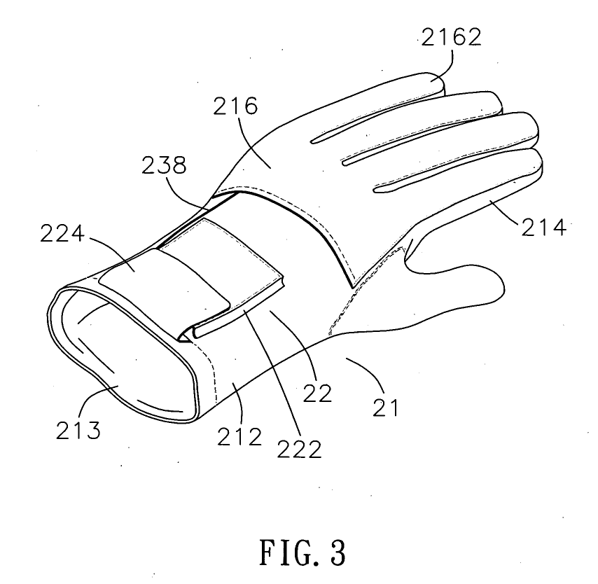

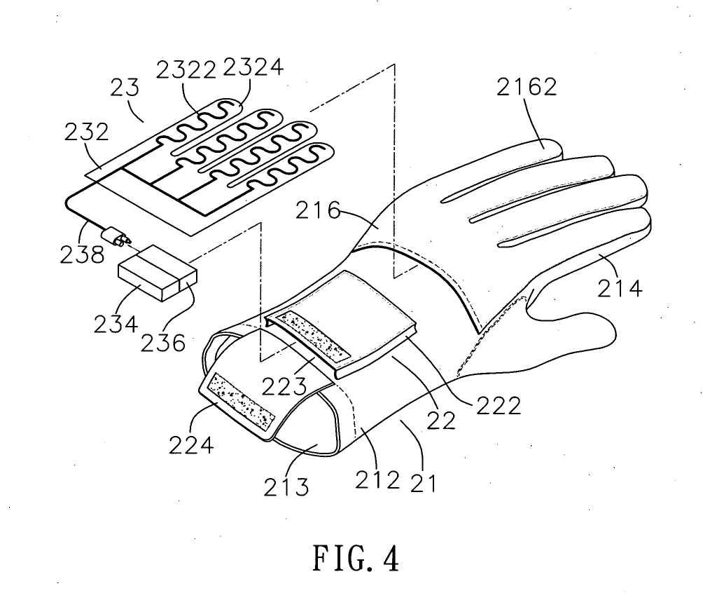

Referring to FIGS. 3 and 4, the inner part 21 for a glove comprises a palm pouch 212 and a finger pouch 214 which is connected to the palm pouch 212. The palm ouch 212 includes a first opening 213 in a first end thereof and the finger pouch 214 is located at a second end of the palm pouch 212. The finger pouch 214 includes five finger spaces and the first opening 213 communicates with an interior of the palm pouch 212 and the finger spaces of the finger pouch 214. An outer bag 216 is mounted to the finger pouch 214 so as to define four finger pockets 2162 between the finger pouch 214 and the outer bag 216.

A receiving unit 22 is located on the palm pouch 212 and includes a receiving pocket 222 which has a second opening 223. A cover 224 removably seals the second opening 223 of the receiving pocket 222 by using hook-loop strips. The second opening 223 is located beside the first opening 213.

An electro-heat unit 23 includes a heat plate 232, a power source 234 and a controller 236, wherein the heat plate 232 is electrically connected to the power source 234 by a cable 238 and the controller 236 is electrically connected to the power source 234. The heat plate 232 includes four insertion plates 2324 and each insertion plate 2324 has a heating item 2322 received therein. The heating items 2322 is connected to the cable 238 and heated by electric power generated from the power source 234. The insertion plates 2324 are removably inserted into the finger pockets 2162, and the power source 234 and the controller 236 are received in the receiving pocket 222 from the second opening 223. The power source 234 can be any known power supply unit such as rechargeable batteries.

The user wears the inner part 21 and then wears a glove, the electro-heat unit 23 provide temperature to the wearer by operation of the controller 236 to set the temperature and time of heating. The power source 234 and the controller 236 are conveniently received in the receiving pocket 222 and the cable 238 extends from a gap between the cover 224 and the outer bag 216. The power source 234 and the controller 236 can be easily taken out from the outer bag 216. The electro-heat unit 23 can also be easily removed from the finger pockets 2162. The glove and the inner part 21 can be cleaned without being connected with the power source 234, the controller 236 and the electro-heat unit 23. Any of the inner part 21, the glove, the power source 234, the controller 236 or the electro-heat unit 23 can be replaced with a new one conveniently.

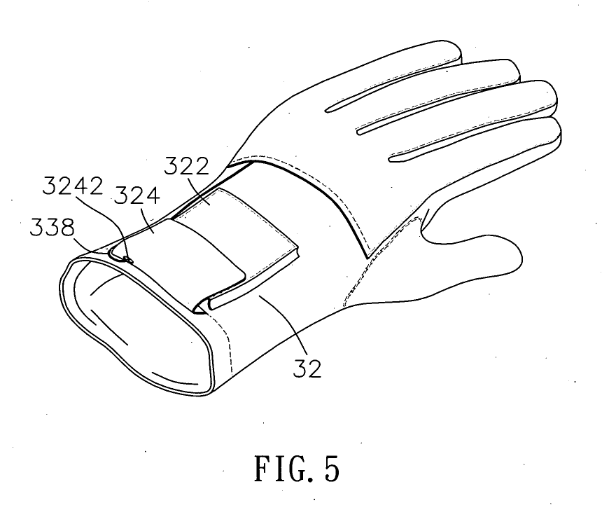

FIG. 5 shows that the cover 324 connected to the outer bag 322 on the palm pouch 32 can include a through hole 3242 and the cable 338 extends through the through hole 3242.

While the inventor have shown and described the embodiment in accordance with the present invention, it should be clear to those skilled in the art that further embodiments may be made without departing from the scope of the present invention.

What is claimed is:

1. An inner part for a glove, comprising:
a palm pouch and a finger pouch which is connected to the palm pouch, the palm ouch including a first opening in a first end thereof and the finger pouch located at a second end of the palm pouch, the first opening communicating with an interior of the finger pouch, an outer bag mounted to the finger pouch and including multiple finger pockets;
a receiving unit located on the palm pouch and including a receiving pocket, a cover removably sealing a second opening of the receiving pocket, and
an electro-heat unit including a heat plate, a power source and a controller, the heat plate electrically connected to the power source by a cable and the controller being electrically connected to the power source, the heat plate including multiple insertion plates and each insertion plate having a heating item received therein, the heating items connected to the cable and being heated by electric power, the insertion plates removably inserted into the finger pockets and the power source and the controller being received in the receiving pocket.

2. The inner part for a glove as claimed in claim 1, wherein the cover includes a through hole and the cable extends through the through hole.

3. The inner part for a glove as claimed in claim 1, wherein the cover is removably attached to the receiving pocket by hook-loop strips.

4. The inner part for a glove as claimed in claim 1, wherein four finger pockets are defined between the finger pouch and the outer bag.

5. The inner part for a glove as claimed in claim 1, wherein the second opening is located beside the first opening.

6. The inner part for a glove as claimed in claim 1, wherein the power source includes rechargeable batteries.
